(19) United States
(12) Patent Application Publication
(10) Pub. No.: US 2009/0258785 A1
(43) Pub. Date: Oct. 15, 2009

(54) Corn gluten meal with aluminum silicate

(76) Inventor: Angelo Lamanna, Toronto (CA)

Correspondence Address: COLEMAN SUDOL SAPONE, P.C., 714 COLORADO AVENUE, BRIDGE PORT, CT, 06605-1601, US

(21) Appl. No.: 12/082,820

(22) Filed: Apr. 14, 2008

(51) Int. Cl. A01N 65/00; C05F 11/00; A01P 21/00

(52) U.S. Cl. 504/116.1; 71/23

(57) ABSTRACT

A pelletized corn gluten meal having a coating of particulate aluminum silicate, for example as provided by pulverized kaolin clay, is provided for use as an herbicide or as a fertilizer. A method of manufacture of the pelletized corn gluten meal provides for the conditioning of powdered corn gluten meal with a moisturizing agent and a binding agent, pelletization of the conditioned corn gluten meal, and dusting with aluminum silicate or pulverized kaolin clay.

### BACKGROUND

1. Technical Field

This invention relates to a natural herbicide and fertilizer and a method of its manufacture, and in particular to the manufacture and use of corn gluten meal as a fertilizer and pre-emergence weed control.

2. Description of Related Art

The use of corn gluten meal as a natural, pre-emergence weed controller or herbicide is generally known, as described for example in United States Reissue Patent No. 34,594, reissued to Christians, Apr. 26, 1994. Corn gluten meal is a product of a corn wet milling process, which extracts various components from corn kernels in an aqueous process. The process of extracting corn gluten meal from corn is well understood by those of ordinary skill in the art, as is its use both as a natural herbicide and a fertilizer. Typically when used as an herbicide, the corn gluten meal is applied prior to germination of the weed or other target vegetation. After germination, corn gluten meal may act as a fertilizer, containing up to about 10% nitrogen.

Corn gluten meal may be provided in a powdered or a pelletized form. The pelletized form is often preferable because it is less likely to blow away after spreading or distribution on the soil or vegetation. However, because the meal is activated through watering, which incorporates the meal into the soil, excessive moisture in the soil or other vegetation to which the corn gluten meal is applied may impede the distribution of the meal in the targeted area.

### SUMMARY

It is therefore desirable to provide a pelletized corn gluten meal form, and a method of manufacture of pelletized corn gluten meal, that overcomes disadvantages of existing forms of corn gluten meal. Thus, in accordance with a first embodiment, a pelletized corn gluten meal is provided, wherein the pelletized corn gluten meal comprises a coating of aluminum silicate or a compound thereof, which may be provided in the form of pulverized kaolin clay. In a further aspect, the pelletized corn gluten meal is formed of corn gluten meal mash comprising a moisturizing agent and a binding agent, where the moisturizing agent may be water and the binding agent a food-grade oil.

In still a further aspect, a method of manufacturing pelletized corn gluten meal is provided, comprising pelletizing powdered corn gluten meal, and conditioning the corn gluten meal thus pelletized with an aluminum silicate conditioning agent such that aluminum silicate adheres to the surface of the pelletized corn gluten meal. Conditioning the corn gluten meal thus pelletized with the aluminum silicate conditioning agent may comprise dusting the pelletized corn gluten meal with particulate aluminum silicate.

The pelletized corn gluten meal thus provided may be used as an herbicide or as a fertilizer.

### BRIEF DESCRIPTION OF THE DRAWINGS

In drawings which illustrate by way of example only a preferred embodiment,

FIG. 1 is a flowchart illustrating a process for the manufacture of pelletized corn gluten meal with an aluminum silicate-based coating.

FIG. 2 is a flowchart illustrating a further process for the manufacture of pelletized corn gluten meal with an aluminum silicate-based coating.

### DETAILED DESCRIPTION

Prior to application as a natural herbicide or as a fertilizer, preferably the corn gluten meal is pelletized for ease in distribution on soil or vegetation. It has been discovered that a coating of aluminum silicate, which may be derived from either a synthetic or a natural source, and in one embodiment from a natural source such as kaolin clay, on the exterior of pelletized corn gluten meal provides unexpected advantages: first, the coating extends the shelf life of packaged, pelletized corn gluten meal by absorbing residual moisture present in the pelletized meal and/or moisture that may penetrate the package; secondly, by delaying the dissolution of the pelletized corn gluten meal once spread on soil or other vegetation; and thirdly, by suppressing the scent of the corn gluten meal, thus reducing its attractiveness to pests and rodents.

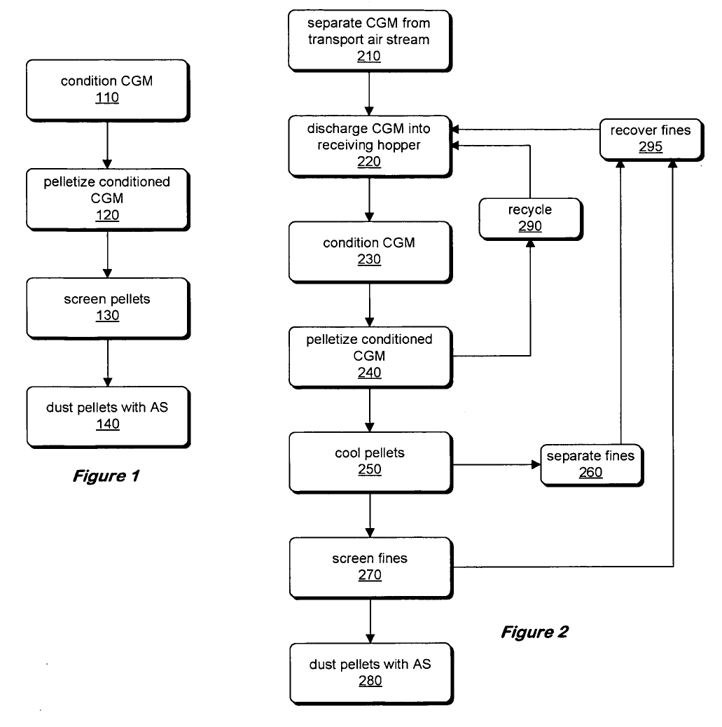

An overview of the manufacture of pelletized corn gluten meal with aluminum silicate is illustrated in FIG. 1. Corn gluten meal is extracted from corn meal using processes and equipment generally known in the art, or obtained from commercially available sources. Prior to pelletization, the corn gluten meal is conditioned 110 by increasing the moisture content of the corn gluten meal to approximately 15% moisture by weight. The conditioning step may comprise the addition of water, or a combination of water and a binding agent. The binding agent may include soy oil or corn oil, or a combination of soy oil and corn oil. The conditioned corn gluten meal is then pelletized 120 using a pellet mill. After pelletization, the pellets may be screened 130 to remove outsized or undersized pellets, and to remove corn gluten meal particulates (“fines”). Removed pellets or particulates may be recycled as input into a subsequent pelletization process. The remaining pellets are then conditioned by dusting or coating with pulverized aluminum silicate (e.g., kaolite clay) 140.

A further process of manufacture is depicted in greater detail in FIG. 2.

Corn gluten meal, typically in a powdered form, is provided as an input to a pellet mill at 220. While commercially obtained corn gluten meal may be directly fed to the pellet mill, in a preliminary step in one embodiment, corn gluten meal obtained from a corn wet milling process may be transferred from a storage location to the pellet mill. For example, at 210, corn gluten meal from a corn wet mill is transferred by a transfer system to the pellet mill, for example using a transport air stream at 220. In such a transport system, the corn gluten meal may be is pneumatically transferred from the storage location through a storage location airlock, using a transfer blower, to a receiving blower and a discharge airlock leading to an input hopper filter, which discharges the input corn gluten meal into the pellet mill.

The pellet mill at 220 may be provided with a receiving hopper for managing the feed supply to the pellet mill. The receiving hopper may be used to provide surge capacity to ensure that the pellet mill receives a consistent feed supply; for example, the receiving hopper may be provided with a level control interlocked to the discharge airlock. When the hopper detects that the input corn gluten meal has reached a predetermined high level, the level control causes the airlock to be closed and no further corn gluten meal is transferred to the hopper until sufficient meal is consumed by the pellet mill such that the level of input corn gluten meal in the hopper drops to a predetermined lower limit. Further, if the hopper detects that the input corn gluten meal has reached a predetermined maximum level or a predetermined minimum level beyond the bounds of the predetermined high or low levels, the level control causes the transfer system to shut down. The hopper may also communicate with a fines recovery system, described below, so that fines collected during later stages of the manufacturing process may be recycled into a subsequent pelletization process.

At 230, prior to pelletization, the corn gluten meal may be conditioned to promote pellet formation. The input corn gluten meal comprises some moisture content, for example approximately 12% by weight. A conditioner comprising a moisturizing agent, for example, water, is added to the corn gluten meal prior to discharging the meal into the pellet mill. The conditioner may also comprise a binding agent, such as soy oil, corn oil, or a combination thereof. An example of a suitable binding agent is Pure Soybean Oil 32770 available from Bunge Canada, Oakville, Ontario, Canada L6L 5N1. Other oils, preferably food-grade oils, may be used. In one embodiment, the conditioner comprises a ratio of binding agent to moisturizing agent of about 2:1, and sufficient conditioner is mixed with the corn gluten meal to achieve a mash with a moisture content of about 15% by weight. It will be appreciated by those skilled in the art, however, that the composition or quantity of the conditioner added may be varied according to the original moisture content of the input corn gluten meal and other environmental factors in the equipment used to process the meal. The conditioner may be fed into the corn gluten meal at a feed spout connecting the hopper to a feed screw leading to the pellet mill. The rate of feed of the conditioner may be determined by measuring the volume of corn gluten meal fed from the discharge airlock into the hopper.

The corn gluten meal mash thus fed to the mill is then pelletized at 240. In one embodiment, pellets of approximately 0.125 inch (3.175 mm) diameter are milled using an internal die, and optionally subject to heat to remove some of the moisture content from the meal. Differently sized pellets may be formed according to the intended end use of the pelletized corn gluten mill. From the mill, the pellets are transferred to a cooler system at 250. However, pellets may be diverted to a recycling system at 290, for example during a start-up cycle or at such other time that the pellets are determined to fall below predetermined quality standards. The recycling system may feed the pellets back to the feed stage 220.

The pellets are transferred to a cooler system at 250, as mentioned above, if it is necessary to cool the pellets as a result of heat generated inside the pellet mill during the pelletization process at 240. The cooler system may utilize evaporative cooling of the pellets on a cooling grate, in which cool ambient air is passed over the surface of the pellets to remove surface moisture. The cool ambient air is provided by a centrifugal fan. During this stage, fines may be blown off the pellets and collected by a cyclone within a repository in the cooler system at 260 (for example, at the bottom of the cooler below the cooling grate). The fines may then be conveyed to a pneumatic fines recovery system for recovery 290, then reutilized as input to the hopper and mill at 220.

The cooled pellets are conveyed to a screening process 270, for example on a conveyor or elevator. Any further fines that are generated during the transportation process are also removed to the fines recovery system. For example, a vibratory screener may be used in the transportation process to extract fines as the pellets are conveyed to the screening process 270. In addition, the screening process 270 may comprise multiple screenings; a first screener may be a scalper to remove oversized pellets. Oversized pellets may also be recycled and subsequently fed back to the feed stage 220. A further screener may be used to remove further fines prior to the next production stage. Fines collected during the transportation process and the screening process 270 may be redirected to the fines recovery system for recovery 290. The fines recovery system comprises a vacuum blower, receiver collector, airlock and a pick-up device. After fines are collected at various points in the manufacturing process, they are conveyed to the top of the hopper, filtered by a filter receiver, and discharged into the hopper.

The screened pellets are then further conditioned at 280. The pellets are conveyed to a further screen and dusted with aluminum silicate to form a coating, preferably in a fine particulate. The coating may, but not necessarily, adhere to the entire surface of each pellet. Suitable particulate aluminum silicate may be provided in the form of powdered kaolin clay, for example ASP® 200 kaolin which is available from Englehard Corporation, Iselin, N.J., 08830-0770. The aluminum silicate may be added through a metering screw into an inlet spout at a vibratory screener, where the pellets are coated up to about 2.5% of aluminum silicate by weight. Any aluminum silicate that does not adhere to the pellets may be reclaimed and recycled back to the metering screw. After this further conditioning stage, the pellets may be packaged.

By providing a partial or complete coating of aluminum silicate or a compound thereof on the surface of the pellets, the shelf life of the corn gluten meal pellets is improved. After pelletization and cooling, the moisture level of the pellets may be significantly reduced, although moisture may remain in the pellets (for example, approximately 2% by weight). The coating absorbs at least a portion of the residual moisture in the pellets, thus retarding the development of mould. Further, the coating also retards the absorption of moisture from external sources into the corn gluten meal pellets, thus promoting improved distribution of the pellets in use, since the dissolution of the pellets once exposed to water when spread on soil or vegetation is delayed. Furthermore, it has been discovered that the aluminum silicate-based coating also suppresses the scent of the corn gluten meal pellets, reducing the likelihood that packaged pellets or distributed pellets will be a target for rodents and other animals.

Various embodiments of the present system having been thus described in detail by way of example, it will be apparent to those skilled in the art that variations and modifications may be made without departing from the invention. The invention includes all such variations and modifications as fall within the scope of the appended claims.

For example, in the foregoing embodiments, the pellet size described is approximately 0.125 inches. Pellets of this size may be distributed using broadcast spreaders and the like, and are generally sufficiently small to provide for effective distribution on the soil. Larger sizes, for example, may not penetrate a vegetation layer (e.g., grass) effectively.

Further, the final percent composition of aluminum silicate and corn gluten meal may vary according to the pellet composition and the degree of adhesion of aluminum silicate to the pellets. For example, when kaolin clay is used, the final composition of kaolin clay in the coated pellets may be approximately 2.5% by weight. The final moisture content of the pellets may be approximately 2% by weight, but may also be higher or lower without adverse effect on the adhesion of the aluminum silicate.

1. Pelletized corn gluten meal having a coating comprising aluminum silicate.

2. The pelletized corn gluten meal of claim 1, wherein the coating comprises pulverized kaolin clay.

3. The pelletized corn gluten meal of claim 1, wherein the pelletized corn gluten meal comprises up to about 2% by weight of water.

4. The pelletized corn gluten meal of claim 1, wherein the pelletized corn gluten meal comprises up to about 2.5% by weight of aluminum silicate.

5. The pelletized corn gluten meal of claim 1, wherein the coating is applied by dusting onto to the surface of corn gluten meal pellets.

6. The pelletized corn gluten meal of claim 1, wherein the corn gluten meal is in pellets of about 0.125 inch diameter.

7. The pelletized corn gluten meal of claim 1, wherein the pelletized corn gluten meal is formed of corn gluten meal mash comprising a moisturizing agent and a binding agent.

8. The pelletized corn gluten meal of claim 7, wherein the binding agent comprises an oil.

9. The pelletized corn gluten meal of claim 8, wherein the oil is selected from one or more of soybean oil and corn oil.

10. The pelletized corn gluten meal of claim 8, wherein the oil is a food-grade oil.

11. The pelletized corn gluten meal of claim 1, wherein the coating is disposed over the entire surface of the corn gluten meal pellets.

12. Use of the pelletized corn gluten meal of claim 1 as a pre-emergence weed controller.

13. Use of the pelletized corn gluten meal of claim 1 as a fertilizer.

14. A method of manufacturing pelletized corn gluten meal, comprising:
pelletizing powdered corn gluten meal; and
conditioning the corn gluten meal thus pelletized with an aluminum silicate-based conditioning agent such that the aluminum silicate-based conditioning agent adheres to the surface of the pelletized corn gluten meal.

15. The method of claim 14, wherein conditioning the corn gluten meal thus pelletized with the aluminum silicate-based conditioning agent comprises dusting the pelletized corn gluten meal with particulate aluminum silicate.

16. The method of claim 14, wherein conditioning the corn gluten meal thus pelletized with the aluminum silicate-based conditioning agent comprises dusting the pelletized corn gluten meal with pulverized kaolin clay.

17. The method of claim 14, wherein pelletizing powdered corn gluten meal comprises:
conditioning the powdered corn gluten meal with a first conditioning agent, wherein the conditioning agent comprises a binding agent and a moisturizing agent.

18. The method of claim 17, wherein the binding agent comprises an oil.

19. The method of claim 18, wherein the oil is selected from one or more of soybean oil and corn oil.

20. The method of claim 17, wherein the moisturizing agent comprises water.

21. The method of claim 17, wherein the powdered corn gluten meal thus conditioned with the first conditioning agent comprises up to about 15% by weight water.

22. The method of claim 17, further comprising:
receiving powdered corn gluten meal in a receiving hopper for discharge into a pellet mill for pelletizing the powdered corn gluten meal;
prior to the step of conditioning the corn gluten meal thus pelletized with an aluminum silicate conditioning agent, screening the pelletized corn gluten meal to separate fines from the pelletized corn gluten meal, and redirecting the fines thus screened to the receiving hopper.
